(19) United States
(12) Patent Application Publication
(10) Pub. No.: US 2007/0275286 A1
(43) Pub. Date: Nov. 29, 2007

(54) Method for Cross-Linking Sulfonated Polymers

(76) Inventors: Serge Kaliaguine, Quebec (CA); Keping Wang, Richmond (CA); Serguei Mikhailenko, Quebec (CA); Michael D. Guiver, Ottawa (CA); Gilles P. Robertson, Hull (CA); Peixiang Xing, Gloucester (CA)

Correspondence Address: HOLLAND & KNIGHT LLP;ATTN: STEFAN V. STEIN/ IP DEPT., POST OFFICE BOX 1288, TAMPA, FL, 33601-1288, US

(21) Appl. No.: 10/590,108

(22) PCT Filed: Feb. 23, 2005
(86) PCT No.: PCT/CA05/00261

§ 371 Date: Jul. 23, 2007

Related U.S. Application Data
(60) Provisional application No. 60/546,180, filed on Feb. 23, 2004.

(51) Int. Cl. C08J 5/22

(52) U.S. Cl. 429/33; 429/30

(57) ABSTRACT

A method for the preparation of a cross-linked, sulfonated, proton exchange membrane for fuel cells, which includes: providing a sulfonated polymer, for example SPEEK; dissolving the sulfonated polymer in a polar casting solvent; adding at least one polyol cross-linking agent to obtain a solution, the cross-linking agent being added in a ratio of at least 1 polyol molecules per repeat unit of the sulfonated polymer to generate cross-linking; casting the solution to obtain the membrane; and curing the membrane.

### CROSS-REFERENCE TO RELATED APPLICATIONS

This application claims priority of U.S. provisional patent application 60/546,180 filed on Feb. 23, 2004, the specification of which is hereby incorporated by reference.

### BACKGROUND OF THE INVENTION

a) Field of the invention

The present invention relates to a new method for the preparation of proton exchange membranes (PEM) for fuel cells and, in particular, the method relates to the preparation of PEM based on cross-linked sulfonated polymers.

b) Description of the prior art

Fuel cells generate electricity by direct electrochemical conversion of a fuel and an oxidant. The efficiency of fuel cells is not thermodynamically restricted and greatly surpasses the efficiency of conventional power generation devices since it does not involve fuel burning. Fuel cells include essentially two catalytic electrodes (an anode and a cathode) separated by an electrolyte. The electrolyte can be a liquid, such as alkaline or H₃PO₄ solutions, or a solid, such as oxides or proton exchange membranes (PEMs). In PEM fuel cells, the fuel is oxidized electrochemically to positive charged ions on a first electrode. The protons diffuse across the PEM to recombine with the oxygen ions at the surface of the cathode. The electron current flowing from the anode to the cathode through an external load produces power.

The PEMs separating the electrodes in a fuel cell should have low resistance to diffusion of ions from one electrode to the other. However, they must provide a barrier against fuel and oxidant cross-leaks for keeping them apart. Diffusion or leakage of the fuel or oxidant gases across the membrane leads to power losses and other undesirable consequences. The PEM should also have a high resistance to the electron flow since if the device is even partially shorted out, the power output is reduced.

For reasons of chemical stability, perfluorosulfonic acid polymer membranes, such as the commercially available Dupont's Nafion™, are most widely used both in fuel cell research and industry. However, they suffer from several shortcomings among which their high cost presents a major obstacle on the way towards commercialization. In addition, a loss of proton conductivity above 80° C. and low resistance towards alcohol cross-leaks impose restrictions on the operating temperature and the choice of possible fuels. Many efforts have been recently undertaken to develop hydrocarbon based alternatives to Nafion®, which would be less expensive and free from disadvantages of perfluorinated membranes.

Among the various membranes with diverse mechanical and electrical properties, long-term stability, efficiency and cost, which emerge over the last few years, membranes based on polyether ether ketone (PEEK) have shown considerable promises [G. Pourcelly and C. Gavach, Perfluorinated Membranes, in Ph. Colomban (Ed.) Proton. Conductors: Solids, Membranes and Gels-Materials and Devices, Cambridge University Press, New York, 1992, pp. 294-310; O. Savadogo, Emerging Membranes for Electrochemical Systems: (I) Solid Polymer Electrolyte Membranes for Fuel Cell Systems, J. New Mat. Electrochem. Syst., 1, 1998, 66; T. Kobayashi, M. Rikukawa, K. Sanui, N. Otega, Proton Conducting Polymers Derived from Poly(Ether—Ether Ketone and Poly(4-phenoxybenzoyl-1,4-Phenylene), Solid State Ionics, 106, 1998, 219; J. Kerres, A. Ullrich, and Th. Harring, New Ionomer Membranes and their Fuel Cell Application: 1. Preparation and Characterization, 3^{rd} Int. Symp. on New Materials for Electrochemical Systems, Montreal, Canada, July, 1999, 230; S. M. J. Zaidi, S. D. Mikhailenko, G. P; Robertson, M. D. Guiver, and S. Kaliaguine, J. Membr. Sci, 173, 2000, 17; B. Bonnet, D. J. Jones, J. Rosière, L. Tchicaya, G. Alberti, M. Casciola, L. Massinelli, B. Bauer, A. Peraio, and E. Ramunni, J. New Mat. Electrochem. Syst., 3, 2000, 87]. These membranes were found to possess good thermal stability, appropriate mechanical strength, and high proton conductivity, which depend on their degree of sulfonation (DS). However, the mechanical properties of PEEK tend to deteriorate progressively with sulfonation [X. Jin, M. T. Bishop, T. S. Ellis, and F. E. Karasz, British Polym. J., 17, 1985, 4], which makes the long term stability of the highly sulfonated polymer questionable. The mechanical weakness of non-cross-linked sulfonated polymers initiated several attempts to prepare more stable and mechanically stronger cross-linked PEMs. Sulfonated PEEK (SPEEK) can be conveniently cross-linked through bridging links to the reactive sulfonic acid functions. The first reported cross-linking of SPEEK was carried out using suitable aromatic or aliphatic amines [U.S. Pat. No. 5,438,082]. Later, the use of a similar cross-linker also having terminal amide functions which form imide functionality through a condensation reaction with the sulfonic acid groups of SPEEK was proposed [U.S. Pat. No. 6,090,895]. The imide group is supposed to be acidic and therefore able to participate in proton transfer, contributing to the proton conductivity of the polymer.

Cross-linking of SPEEK can be performed through intra/inter chain condensation of sulfonic acid functionalities allegedly initiated simply by appropriate thermal treatment [U.S. Pat. No.5,795,496].

The cross-linked SPEEK membranes were found to be much less susceptible to swelling than non-cross-linked SPEEK. They are comparable to commercial Nafion® in terms of their mechanical strength, stability and proton conductivity. However no fuel cell performance data for these membranes are currently available in the literature. Furthermore, when amine functions are employed in cross-linking reactions with sulfonic acid groups, sulfanilamide is produced [U.S. Pat. Nos. 5,438,082 and No 6,090,895]. The hydrolytic stability of sulfanilamide is questionable and casts doubts upon the membrane durability under fuel cell operating conditions.

There is thus a need for an inexpensive, mechanically and chemically stable proton conducting polymer for fuel cell applications.

### SUMMARY OF THE INVENTION

It is an object of the present invention to provide a high proton conductivity, low electronic conductivity membrane, which is mechanically strong and chemically stable and can prevent the cross-leaks of molecular gases.

An aspect of the invention provides a method for the preparation of a cross-linked proton exchange membrane. The method comprises: providing a sulfonated polymer; dissolving the sulfonated polymer in a polar casting solvent; adding at least one polyol cross-linking agent to obtain a solution, the at least one polyol cross-linking agent being added in a sufficient ratio of polyol molecules per repeat unit of the sulfonated polymer to generate cross-linking; casting the solution to obtain the membrane; and curing the membrane.

The ratio of polyol molecules per repeat unit of the sulfonated polymer is preferably above 1 and still preferably between 2 and 3.

The sulfonated polymer is preferably dissolved in the polar casting solvent to a concentration ranging between 5 and 25 wt % and, more preferably, to a concentration ranging between 10 and 15 wt %.

Preferably, the solution is agitated prior to casting and the cast solution is outgassed and dried at room temperature. The membrane is preferably cured under vacuum and at gradually increasing temperature. The membrane is preferably cured at a temperature ranging between 25 and 180° C. and, more preferably, between 25 and 150° C.

Preferably, the sulfonated polymer includes a sulfonated poly(ether ether ketone) and the polar casting solvent is selected from the group consisting of DMAc, NMP, DMF, butyrolactone, water, a mixture of water and acetone, and a mixture of water and alcohol and, more preferably, from the group consisting of water, a mixture of water and acetone, and a mixture of water and alcohol.

Preferably, the at least one polyol cross-linking agent includes a diol and, more preferably, the at least one polyol is selected from the group consisting of ethylene glycol and glycerol.

Preferably, the polymer is sulfonated to a degree of sulfonation higher than 0.6 and, more preferably, to a degree of sulfonation higher than 0.75.

Preferably, the sulfonated polymer is dried prior to adding the at least one cross-linking agent.

Another aspect of the invention provides a fuel cell using a cross-linked proton exchange membrane prepared as described hereinabove.

A further aspect of the invention provides a proton exchange membrane suitable for fuel cells. The proton exchange membrane comprises: a cross-linked sulfonated polymer provided from a cast and cured solution, the solution including a sulfonated polymer dissolved in a polar casting solvent and at least one polyol cross-linking agent added to the dissolved sulfonated polymer in a ratio of the cross-linking agent molecules per repeat unit of the sulfonated polymer sufficient to generate cross-linking.

The ratio of polyol molecules per repeat unit of the sulfonated polymer in the solution is preferably above 1 and, more preferably, between 2 and 3.

The sulfonated polymer is preferably dissolved in the polar casting solvent to a concentration ranging between 5 and 25 wt % and, more preferably, to a concentration ranging between 10 and 15 wt %.

Preferably, the cast solution is outgassed and is dried at room temperature.

The solution is preferably cured under vacuum and a temperature that is gradually increased. The curing temperature preferably ranges between 25 and 180° C. and, more preferably, between 25 and 150° C.

Preferably, the sulfonated polymer includes a sulfonated poly(ether ether ketone) and the polar casting solvent is selected from the group consisting of DMAc, NMP, DMF, butyrolactone, water, a mixture of water and acetone, and a mixture of water and alcohol and, more preferably, is selected from the group consisting of water, a mixture of water and acetone, and a mixture of water and alcohol. Preferably the cross-linking agent is selected from the group consisting of ethylene glycol and glycerol.

The sulfonated polymer has preferably a degree of sulfonation higher than 0.6 and, more preferably, higher than 0.75. The sulfonated polymer is preferably dried prior to adding the at least one cross-linking agent.

Another aspect of the invention provides a method for the preparation of a cross-linked proton exchange membrane. The method comprises: providing a sulfonated polymer having a degree of sulfonation higher than 0.6; dissolving the sulfonated polymer in a polar casting solvent; adding at least one polyol cross-linking agent to obtain a solution, the at least one polyol cross-linking agent being added in a ratio of polyol molecules per repeat unit of the sulfonated polymer higher than or equal to 1 to generate cross-linking; casting the solution to obtain the membrane; and curing the membrane.

A further aspect of the invention provides a proton exchange membrane suitable for fuel cells. The proton exchange membrane comprises: a cross-linked sulfonated polymer provided from a solution which has been cast and cured, the solution including a sulfonated polymer, having a degree of sulfonation higher than 0.6, dissolved in a polar casting solvent and at least one polyol cross-linking agent added to the dissolved sulfonated polymer in a ratio of the cross-linking agent molecules per repeat unit of the sulfonated polymer higher than or equal to 1 to generate cross-linking.

### BRIEF DESCRIPTION OF THE DRAWINGS

Further features and advantages of the present invention will become apparent from the following detailed description, taken in combination with the appended drawings, in which:

FIG. 1 is a graph showing the sulfur content in cross-linked and non-cross-linked SPEEK membranes as function of the treatment temperature: (a) DS determined by titration and sulfur content calculated from DS; (b), (c), and (d) sulfur content determined by elemental analysis and DS calculated from sulfur content; (e) DS determined by H¹NMR and sulfur content calculated from DS (for sample designation see Table 1), EG means the [ethylene glycol]/[SPEEK] molar ratio used in the membrane preparation;

FIG. 2 is a graph showing the preparation formulations of different SPEEK samples;

FIG. 3 is a possible reaction of SPEEK cross-linking; and

FIG. 4 is a graph showing swelling and proton conductivity of cross-linked SPEEK membranes as function of DS, measured by titration (Nafion® 117 conductivity measured in the same cell and under the same conditions was σ (25° C.)=3.3×10⁻² S/cm), the values in parentheses are the [ethylene glycol]/[SPEEK] molar ratios used in the membrane preparation.

### DETAILED DESCRIPTION OF THE PREFERRED EMBODIMENT

The present invention relates to a method for the preparation of cross-linked sulfonated polymer membranes that can be used as proton conductive membranes in proton exchange membrane fuel cells.

A sulfonated polymer is first provided by sulfonating of an appropriate polymer. The preferred starting material is polyetheretherketones (PEEK), which are a temperature resistant and oxidatively stable engineering polymers. However, any other appropriate polymer that can be sulfonated can be used. Several sulfonation techniques are well-known by those skilled in the art. A sulfonation technique is described below in the examples but any appropriate technique can be applied. Polymers having a high degree of sulfonation (DS), i.e. above 0.6, are preferred.

The sulfonated polymer, which is preferably dried, is then dissolved in a polar organic solvent such as N,N-dimethylacetamide (DMAc), dimethylformamide (DMF), N-methyl-2-pyrrolidone (NMP), butyrolactone, water-acetone, water-alcohol mixtures or a polar inorganic solvent such as water. A diluted solution is thus obtained wherein the sulfonated polymer concentration varies between 10 and 15 wt %. The diluted solution is usually cast at room temperature and then cured under vacuum at 25-150° C. for few days.

However, as it will be shown in the following examples, a thermal treatment is not sufficient to induce any significant cross-linking at least below 120-150° C. Indeed, sulfonated poly(ether ether ketone) (SPEEK) materials having a DS ranging from 0.6 to 1.0 cast at room temperature from the above-mentioned solvents remained soluble in these solvents after drying and curing under vacuum at 120-150° C. for several days. This observation is contradictory with previous assertions [U.S. Pat. No. 5,795,496] stating that heating high DS SPEEK materials to 120° C. is sufficient to initiate thermal cross-linking.

Experimentations showed that high DS SPEEK materials heated up to 250° C. under vacuum resulted in membranes which are insoluble in any solvent (except H₂SO₄) and stable in boiling water. In some instances this thermally induced transformation started at 220° C. The chemical analysis of these samples also showed that heating above 200° C. brings about desulfonation of SPEEK accompanied by SO₃ release.

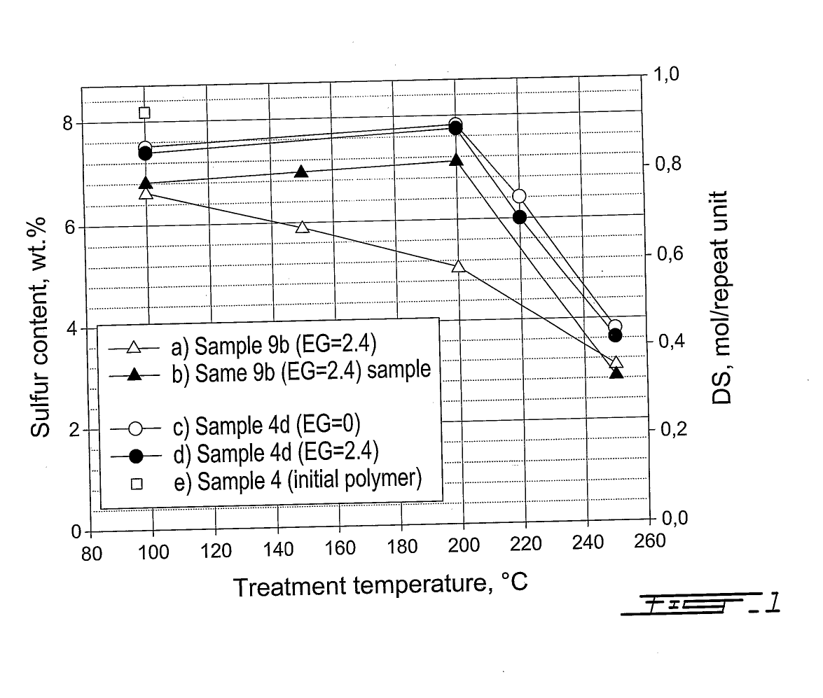

The results of sulphur elemental analysis for four membrane samples treated at different temperatures are presented in FIG. 1. A pure (containing no cross-linker) SPEEK membrane cast from NMP solution and treated at different temperatures is represented by curve (c) in FIG. 1. The sample studied had a DS 0.94 according to nuclear magnetc resonance (NMR) analysis (¹H NMR analysis) (see Table 1), which corresponds to a calculated value of 8.2 wt. % of sulphur. It can be seen from FIG. 1 that the initial sulphur content (sample 4d dried at 100° C.) determined by chemical analysis is by 9 wt % lower than the value calculated from NMR. Heating to 200° C. reduced the discrepancy between the results of these two analytical techniques, which suggests that this difference can be associated with the presence of residual NMP solvent in the membrane. However, NMP is difficult to remove completely as its boiling point is 202° C.

Heating above 200° C. under vacuum strongly reduces the sulphur content below the values corresponding to DS 0.5, as shown on curve (c) of FIG. 1. These SPEEK samples become insoluble in many solvents and might be mistaken for thermally cross-linked. However, this increase of chemical stability should be mostly caused by desulfonation as it is known at low DS pure SPEEK is insoluble in any solvent except concentrated H₂SO₄. At the same time when initially the same samples were treated under vacuum not above 200° C. but at 150° C. for several days, these membranes remained soluble and did not show any properties of cross-linked polymers.

U.S. Pat. No. 5,795,496 reports cross-linking of SPEEK with a treatment temperature of 120° C., which is significantly lower than the onset temperature of desulfonation. A plausible explanation for this observed cross-linking at this low temperature is that some other fortuitous reactions occurred in the experiments reported during curing of SPEEK.

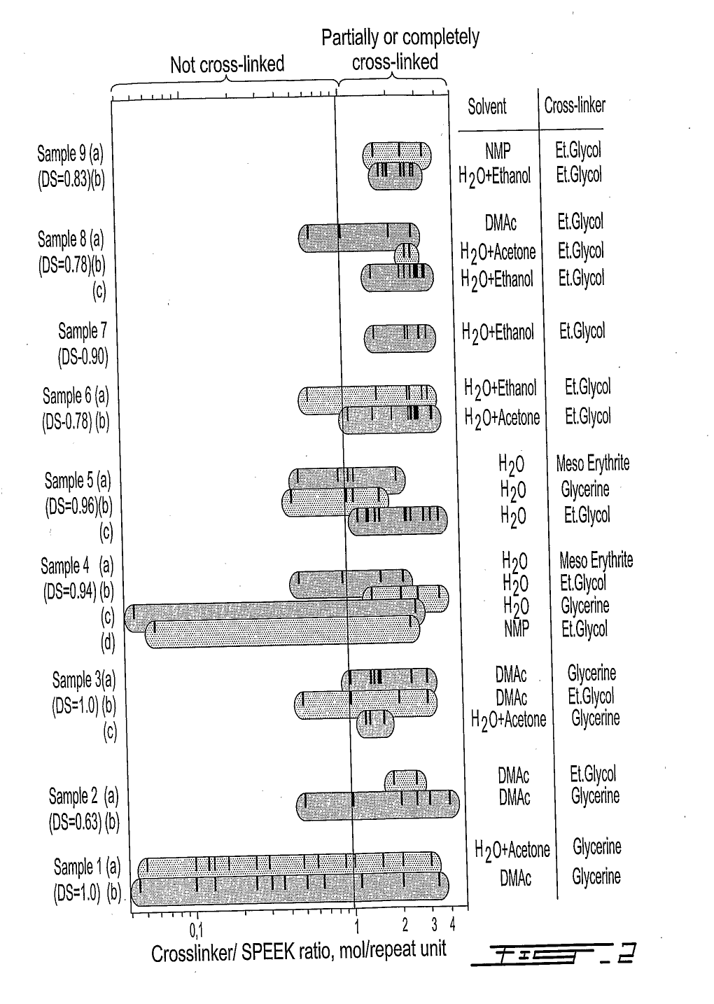

The experiments carried out in the examples described below revealed the role of polyols in cross-linking of sulfonated linear polymers. In all the experimental preparations, where the casting medium contained certain amounts of glycerol, cross-linking indeed was observed: membranes changed colour from brownish-yellow to black and became mechanically stronger and insoluble in any of the solvents used. That occurred, when the ratio of glycerol to SPEEK was at least 1 molecule per repeat unit of the polymer. This can be seen in FIG. 2, where the stroke marks indicate numerous preparations that make a representative set of statistical data.

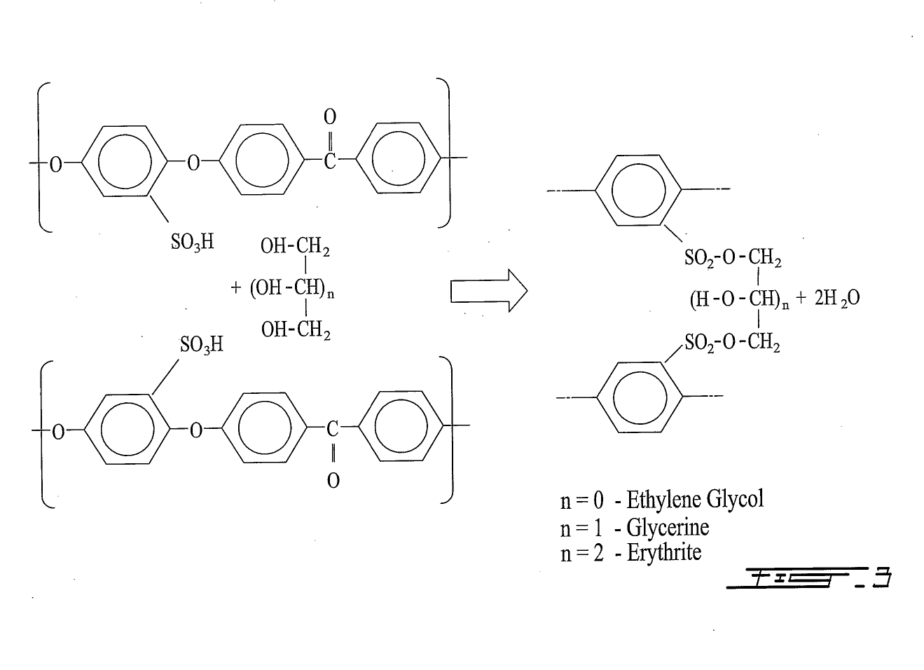

The chemical reaction assumed to be involved in such cross-linking is shown in FIG. 3. The glycerol, participating in the bridging of SPEEK fragments, can be replaced by any polyol. A number of preparations was carried out using ethylene glycol (two-carbon) and mesoerythrite (four-carbon) polyols (see FIG. 3). It was observed, that starting from a certain molar ratio of cross-linker to SPEEK the reaction of polycondensation apparently occurs and some of the products obtained became insoluble in boiling water and organic solvents. The preparation formulations of different SPEEK membranes, including casting solvent and cross-linking polyol used, are listed in FIG. 2. In order to initiate cross-linking the films are dried after casting and cured according to the procedure described in U.S. Pat. No. 5,795,496 or even sometimes under more stringent conditions (curing temperature up to 150° C. instead of 120° C.).

To provide cross-linked sulfonated polymers, an amount of a polyol (or polyatomic alcohol) cross-linker such as glycerol (or glycerine), ethylene glycol and meso-erythritol is added to a diluted sulfonated polymer solution. As mentioned above, polar organic or inorganic solvents can be used to dilute the sulfonated polymer. The concentration of the diluted solution varies between 5 and 25 wt %, preferably between 10 and 15 wt %. More concentrated solutions produce thicker films while less concentrated produce thinner films. The solution is then agitated for a sufficient amount of time and outgassed. The outgassed polymer solution is cast and dried at ambient temperature. The dried polymer is then cured under vacuum at a gradually increasing temperature. Preferably, the temperature increases between 25 and 180° C.

As it will be explained in more details below, cross-linking is observed when the casting medium contains a certain amount of a polyol: the membranes changed of color and become mechanically strong and insoluble in any solvent used. Cross-linking generally occurs when the ratio of polyol to sulfonated polymer is at least one molecule per repeat unit of polymer. FIG. 3 shows the chemical reaction assumed to be involved in such cross-linking.

Several examples were carried out to analyze the effect of polar organic and inorganic solvents and polyol cross-linkers on the cross-linking of a sulfonated polymer.

### EXAMPLE 1

### PEEK Sulfonation

PEEK extrudate samples were first provided. The PEEK samples used for this example are PEEK™ produced by Victrex®. Typically 20 g of PEEK was dried in a vacuum oven at 100° C. and then dissolved in 500 ml of concentrated (95-98% H₂SO₄) sulfuric acid at 50-90° C. under vigorous mechanical stirring to produce a polymer solution. The reaction time ranged from 1 to 6.5 hours. To stop the sulfonation reaction and produce a polymer precipitate, the polymer solution was decanted into a large excess of ice-cold water under continuous mechanical agitation. For samples with a DS of <0.8, the polymer precipitate was filtered and washed several times with distilled water until the pH was neutral. For water swellable or soluble samples with DS>0.8, residual sulfuric acid was removed by dialysing the polymer. The polymer was then dried under vacuum for 1-2 days at 25-40° C. to obtain a dry SPEEK polymer. The degree of sulfonation was determined by nuclear magnetic resonance (NMR) analysis ¹H NMR in accordance with techniques known in the art.

### EXAMPLE 2

### Membrane Preparation

The dry SPEEK polymers were dissolved in one of the following solvents: dimethylacetamide (DMAc), dimethylformamide (DMF), N-methyl-pyrrolidinone (NMP), water-acetone or water-alcohol mixtures to a 10-15 wt % SPEEK solution. Various amounts of diol or polyol cross-linkers were added to the SPEEK solutions and the solutions were agitated for 30 minutes. Glycerol, meso-erythritol and ethylene-glycol cross-linkers were added in different samples of the diluted SPEEK solution. Then, the solutions were outgassed for 30 minutes and cast onto a glass plate. The cast solution were dried under ambient conditions for several days and then cured under vacuum at 25-150° C. for a few more days.

FIG. 2 lists the preparation formulations of the different SPEEK samples tested.

### EXAMPLE 3

### Characterization of SPEEK Membranes

The ¹H-NMR spectra were recorded on a Varian Unity Inova spectrometer at a resonance frequency of 399.961 MHz. For each analysis, a 2-5 wt % polymer solution was prepared in DMSO-d6 (deuterated dimethylsulfoxide) and tetramethylsilane (TMS) was used as the internal standard. The DS was determined by comparative integration of distinct aromatic signals. Alternatively the DS was determined by titration: 1-2 g of the SPEEK was placed in 0.5 M aqueous NaOH and kept for one day. The solution was then back titrated with 0.5 M HCl using phenolphthalein as an indicator.

The amount of water absorbed in SPEEK membranes was determined by comparison of weights of a blotted soaked membrane and vacuum dried one. The water uptake was calculated with reference to the weight of the dry specimen: (W_{wet}/W_{dry}−1)×100%.

The proton conductivity of the polymer membranes was measured by AC impedance spectroscopy using a Solartron® 1260 analyzer across 13 mm diameter samples clamped between two blocking stainless steel electrodes. The sample discs where hydrated by soaking in water overnight and placed wet in the measurement cell. The conductivity (σ) of the samples was calculated from the impedance data using the relation σ=d/(R*S) where d and S are the thickness and the face area of the sample respectively, and R was derived from the low intersect of the high frequency semi-circle on a complex impedance plane with the Re(Z) axis. The impedance data were corrected for the contribution from the empty and short-circuited cell.

Result Analysis

Table 1 presents the results of the cross-linking procedure along with the conductivity values of the preparation of formulations of the different SPEEK samples tested and listed in FIG. 2.

Sample 1 with a DS of 1.0 was rendered completely cross-linked (insoluble in any solvent) only when cast from a water-acetone solution and when the glycerol content was higher than one molecule per repeat unit of SPEEK (Sample 1b). When DMAc was used as casting solvent, no. (or only partial) cross-linking occured even at high glycerol concentration.

TABLE 1
Properties of the SPEEK membranes after the cross-linking (part I)

| | | | Cross- | | | | |
|---|---|---|---|---|---|---|---|
| | | | linker/ | | | | |
| | | | SPEEK | | | | |
| | | | Ration, mol/ | | | | |
| Sample | | Cross- | repeat | Cure condition | | Conduc- | |
| (DS)* | Solvent | linker | unit | T, ° C. | Time h | tivity, S/cm | Comments |
| 1a | DMAc | Glycerol | <1 | 125 | 36 | — | Soluble in |
| (1.0) | | | | | | | water |
| | | | >1 | 130 | 72 | ≦1.5 × 10⁻² | Partially |
| | | | | | | | soluble in |
| | | | | | | | DMAc, H₂O |
| 1b | Water + | Glycerol | <1 | 125 | 48 | — | Soluble in |
| (1.0) | acetone | | | | | | water |
| | | | > | 120 | 48 | ≦2.5 × 10⁻² | Complete |
| | | | | | | | cross-linking |
| 2a | DMAc | Ethylene- | > | 125 | 48 | — | Partially |
| (0.63) | | glycol | | | | | soluble in |
| | | | | | | | DMAc |
| 2b | DMAc | Glycerol | < | 125 | 48 | ≦2 × 10⁻³ | Soluble in |
| (0.63) | | | | | | | DMAc |
| | | | > | | | ≦5.7 × 10⁻³ | Partially |
| | | | | | | | soluble in |
| | | | | | | | DMAc |
| 3a | DMAc | Glycerol | =1 | 130 | 66 | 7.8 × 10⁻³ | Soluble |
| (1.0) | | | | | | | water |
| | | | >1 | 130 | 66 | ≦1 × 10⁻² | Partially |
| | | | | | | | soluble in |
| | | | | | | | DMAc |
| 3b | DMAc | Ethylene- | >1 | 130 | 66 | ≦1.5 × 10⁻² | Partially |
| (1.0) | | glycol | | | | | soluble in |
| | | | | | | | DMAc |
| 3c | Water + | Glycerol | >1 | 125 | 60 | — | Complete |
| (1.0) | acetone | | | | | | cross-linking |

Properties of the SPEEK membranes after the cross-linking (part II)

| | | | Cross- | | | | |
|---|---|---|---|---|---|---|---|
| | | | linker/ | | | | |
| | | | SPEEK | | | | |
| | | | Ration, mol/ | | | | |
| Sample | | Cross- | repeat | Cure condition | | Conduc- | |
| (DS)* | Solvent | linker | unit | T, ° C. | Time h | tivity, S/cm | Comments |
| 4a | Water | Meso- | <1 | 135 | 60 | — | Soluble in |
| (0.94) | | Erythritol | | | | | water |
| | | | > | 135 | 60 | ≦2.2 × 10⁻² | Complete |
| | | | | | | | cross-linking, |
| | | | | | | | brittle |
| 4b | Water | Ethylene- | = 1.4 | 135 | 60 | 2.2 × 10⁻² | Soluble in |
| (0.94) | | glycol | | | | | water |
| | | | 1.4 | 135 | 60 | ≦2.2 × 10⁻² | Complete |
| | | | | | | | cross-linking |
| 4c | Water | Glycerol | 2.6 | 135 | 60 | 2.2 × 10⁻² | Complete |
| (0.94) | | | | | | | cross-linking |
| 4d | NMP | Ethylene- | <2.7 | 150 | 60 | ≦4 × 10⁻² | Soluble in |
| (0.94) | | glycol | | | | | hot water |
| 5a | Water | Meso- | 0.5-0.9 | 140 | 48 | — | Soluble in |
| (0.96) | | Erythritol | | | | | water |
| | | | 1-2 | 140 | 48 | — | Cross-linked, |
| | | | | | | | brittle |
| 5b | Water | Glycerol | >1 | 140 | 48 | ≦1.2 × 10⁻² | Complete |
| (0.96) | | | | | | | cross-linking |
| 5c | Water | Ethylene- | ≦1.5 | 140 | 48 | ≦2.2 × 10⁻² | Soluble in |
| (0.96) | | Glycol | | | | | water at |
| | | | | | | | 100° C. |
| | | | >1.5 | 140 | 48 | ≦2.7 × 10⁻² | Complete |
| | | | | | | | cross-linking |
| 6a | Water + | Ethylene- | 0.6 | 140 | 60 | — | Soluble in |
| (0.78) | Alcohol | Glycol | | | | | water |
| | | | >1.6 | 140 | 60 | ≦2.5 × 10⁻² | Complete |
| | | | | | | | cross-linking |

Properties of the SPEEK membranes after the cross-linking (part III)

| | | | Cross- | | | | |
|---|---|---|---|---|---|---|---|
| | | | linker/ | | | | |
| | | | SPEEK | | | | |
| | | | Ration, mol/ | | | | |
| Sample | | Cross- | repeat | Cure condition | | Conduc- | |
| (DS)* | Solvent | linker | unit | T, ° C. | Time h | tivity, S/cm | Comments |
| 6b | Water + | Ethylene- | <1.5 | 140 | 60 | ≦1.6 × 10⁻² | Soluble in |
| (0.78) | acetone | Glycol | | | | | water at |
| | | | | | | | 100° C. |
| | | | >1.5 | 140 | 60 | ≦2.5 × 10⁻² | Complete |
| | | | | | | | cross-linking |
| 7 | Water + | Ethylene- | >1.6 | 140 | 60 | ≦4.2 × 10⁻² | Complete |
| (0.90) | Alcohol | Glycol | | | | | cross-linking |
| 8a | DMAc | Ethylene- | <1 | 150 | 68 | — | Soluble in |
| (0.78) | | Glycol | | | | | DMAc, hot |
| | | | | | | | water |
| | | | >1 | 150 | 68 | — | Partially |
| | | | | | | | soluble in |
| | | | | | | | DMAc |
| 8c | Water + | Ethylene- | >1.5 | 150 | 68 | ≦2.6 × 10⁻² | Complete |
| (0.78) | Alcohol | Glycol | | | | | cross-linking |
| 9a | NMP | Ethylene- | 1.65-3.3 | 150 | 68 | ≦4.6 × 10⁻² | Soluble in |
| (0.83) | | Glycol | | | | | water at |
| | | | | | | | 100° C. |
| 9b | Water + | Ethylene- | <1.9 | 150 | 68 | ≦6.5 × 10⁻² | Soluble in |
| (0.83) | Alcohol | Glycol | | | | | water at |
| | | | | | | | 100° C. |
| | | | >1.9 | 150 | 68 | ≦4 × 10⁻² | Complete |
| | | | | | | | cross-linking |

*Measured by NMR before membrane casting

The same was observed for all samples; whether they were low DS (Samples 2a and 2b), mid-DS (Sample 8a) or high DS (Samples 1a, 3a, and 3b). When the membranes were prepared using low cross-linker concentration, the membranes (Samples 1a, 1b, and 3) remained soluble even in cold water, indicating that no or only little cross-linking occurred. At higher cross-linker concentration, membranes were partially soluble in DMAc indicating that cross-linking was incomplete. Similar observations applied for another casting solvent NMP (samples 4d and 9a). It is apparent that cross-linking was blocked by the competing reaction of sulfonic acid groups with DMAc or NMP.

Recently it has been shown that DMAc and especially DMF form strong hydrogen bonding with sulfonated PEEK. Moreover, both solvents have been found to be prone to thermally activated decomposition, accelerated by sulfonic acid functions and the produced dimethylamine also forms strong bonding with SPEEK [G.P. Robertson, S. D. Mikhailenko, K. P. Wang, P. X. Xing, M. D. Guiver, and S. Kaliaguine, Casting Solvent Interactions with Sulfonated Poly(Ether Ether Ketone) during Proton Exchange Membrane Fabrication, J. Membr. Sci, 219 (2003) 113; S. Kaliaguine, S. D. Mikhailenko, K. P. Wang, P. X. Xing, G. Robertson, M. D. Guiver, Properties of SPEEK based PEMs for Fuel Cell application, Catalysis Today, 82 (2003) 213]. It is therefore preferable to avoid these solvents for membrane casting replacing them whenever possible (SPEEK with DS above 0.8) by water or water-acetone mixtures. Water-alcohol mixture can also be used because there is little likelihood of hydroxyl interaction with acid groups due to the very low boiling point of ethanol, which is about 4° C. under vacuum. This is sustained by the fact that the proton conductivity of a water-alcohol cast membrane is no different from that obtained from a water-acetone solvent. Samples 6a and 6b of Table 1 are completely cross-linked when a high concentration of a polyol cross-linker was added to the casting solution.

It is interesting to note that the introduction of the cross-linker did not change the sulfur content of the membranes treated at different temperatures, as can be seen from the comparison of curves (c) and (d) in FIG. 1. However, the results of titration turned out to be very different from the results of elemental chemical analysis for sulfur for the cross-linked samples. This can be seen from comparison of curves (a) and (b) in FIG. 1. The disparity in these two curves corresponds to the difference between the amount of sulfur comprised only in sulfonic acid functions (available for ion exchange as used in titration) and the total sulfur content, including bridging —SO₂— functions not detectable by titration but measurable by elemental analysis. Therefore, the difference between sulfur content according to the results of elemental analysis and titration can be a measure of degree of cross-linking: the larger this difference, the greater number of sulfonic functions became bridging.

Among the three cross-linkers used, the best membranes were obtained with ethylene glycol. They were most strong mechanically, flexible and less liable to deformation. Glycerol gave slightly less strong membranes, which sometimes were also less conductive than the ones made with ethylene glycol as can be seen from the comparison, for example, of samples 5b and 5c. Despite the fact that it also ensures SPEEK cross-linking, meso-erythrite results in membranes that are too brittle to be for any practical use (Samples 4a and 5a).

Therefore, the best cross-linked SPEEK membranes are obtained from SPEEK with a high degree of sulfonation, preferably between 0.75 and 1.0, using either water, water-acetone or water-alcohol mixtures as a casting solvent. Any polyols can be used as cross-linker in a ratio above one molecule of cross-linker per SPEEK repeat unit. Preferably, ethylene glycol is used in a ratio between 1.5 and 3 molecules per SPEEK repeat unit. Finally, the 18 wt % solution containing the solvent and the cross-linker should be cast on a glass plate and dried at room conditions for two days, and then under vacuum for three days at a temperature gradually increasing from 25 to 180° C. over two days, preferably between 25 and 150° C.

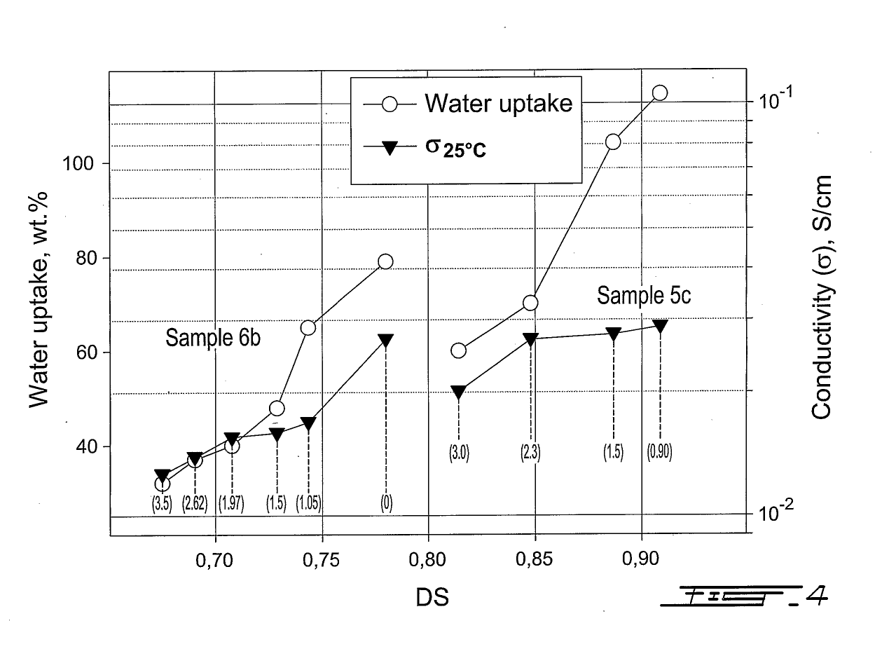

The swelling of a SPEEK membrane in water is commonly thought to be inversely related to its mechanical strength. In FIG. 4, room temperature water uptake along with conductivity of a series of cross-linked membranes are presented as functions of their DSs measured by titration as the number of sulfonic acid functions per repeat unit. As can be seen from FIG. 1, sulfur contents measured by titration (accounting only for sulfonic acid groups, available for ion exchange) are lower than the total sulfur concentration defined by elemental analysis. From FIG. 4, it follows that introduction of increasing amounts of ethylene-glycol into sample 6 caused a gradual decrease in the DS from 0.78 to 0.68, accompanied by more than a twofold water uptake decrease from 79 to 32 wt %. At the same time, the conductivity decreased less significantly from 2.7×10⁻² to 1.4×10⁻² S/cm and remained within the usable range for fuel cell application. The resulting membrane from DS 0.71 (corresponding to a ratio [Etylene-Glycol]/[SPEEK] of 1.97) was completely cross-linked and maintained good mechanical strength even when swollen. It is worth mentioning that conductivity measurements were performed on the membranes that were subjected to boiling in water.

Sample 5c having DS 0.96 was initially soluble in water and therefore its water uptake can be considered as infinity. However at a ratio [Etylene-Glycol]/[SPEEK] of 2.3 and higher it became fully cross-linked with water uptake below 70 wt % and a conductivity above 2×10⁻² S/cm. Such a high conductivity suggests that a major portion of sulfonic acid functions was not involved in cross-linking and remained available for proton transfer. It is important to note that despite cross-linked being far from complete, the membranes were rigid and strong at ambient conditions and, at the same time, became moldable and pliable at temperatures above 150° C. That allows their use in the preparation of membrane-electrode assemblies for FC.

The method for cross-linking of SPEEK developed is based on the thermally activated bridging of the polymer chains with polyatomic alcohols through condensation reaction with sulfonic acid functions. Cross-linking greatly increases the polymer mechanical strength and reduces its swelling in water. Although the cross-linking decreases the number of sulfonic acid groups available for proton transfer, the SPEEK membrane conductivities are only slightly reduced. Some of the samples exhibited a room temperature conductivity above 2×10⁻² S/cm.

The method described hereinabove provides a high proton conductivity, low electronic conductivity membrane, which is mechanically strong and chemically stable and can prevent the cross-leaks of molecular gases.

One skilled in the art will understand that other sulfonated polymers than SPEEKs can be used. For example, without being limitative, the sulfonated polymer can be selected from a whole group of poly(arylene ether)s including in addition to SPEEK also poly(arylene ether sulfone) (PES) and their derivatives, (for instance poly(ether ketone ketone)), and from other groups of polymers like sulfonated poly(imide)s and the like. The polyol is preferably a diol.

The method produces a proton conducting polymer for fuel cells which permits to increase the membrane stability and to reduce the methanol transfer through the polymer.

The embodiments of the invention described above are intended to be exemplary only. For example, even in the above examples used PEEK as starting material, one skilled in the art will appreciate that any other appropriate polymer that can be sulfonated can be used. The scope of the invention is therefore intended to be limited solely by the scope of the appended claims.

1. A method for the preparation of a cross-linked proton exchange membrane, comprising:
providing a sulfonated polymer having a degree of sulfonation higher than 0.6;
dissolving the sulfonated polymer in a polar casting solvent;
adding at least one polyol cross-linking agent to obtain a solution, the at least one polyol cross-linking agent being added in a ration of polyol molecules per repeat unit of the sulfonated polymer higher than or equal to 1 to generate cross-linking;
casting the solution to obtain the membrane; and
curing the membrane.

2. The method of claim 1, wherein the degree of sulfonation of the sulfonated polymer is higher than 0.75.

3. The method of claim 1, wherein the ratio of polyol molecules per repeat unit of the sulfonated polymer is between 2 and 3.

4. The method of claim 1, wherein the sulfonated polymer is dissolved in the polar casting solvent to a concentration ranging between 5 and 25 wt %.

5. (canceled)

6. The method of claim 1, further comprising agitating the solution prior to casting.

7. The method of claim 1, further comprising outgassing the cast solution.

8. The method of claim 1, further comprising drying the cast solution at room temperature.

9. The method of claim 1, further comprising curing the membrane under vacuum.

10. The method of claim 1, wherein the membrane is cured at gradually increasing temperature.

11. The method of claim 1, wherein the membrane is cured at a temperature ranging between 25 and 180° C.

12. (canceled)

13. The method of claim 1, wherein the sulfonated polymer comprises a sulfonated poly(ether ether ketone).

14. The method of claim 1, wherein the polar casting solvent is selected from the group consisting of DMAc, NMP, DMF, butyrolactone, water, a mixture of water and acetone, and a mixture of water and alcohol.

15. (canceled)

16. The method of claim 1, wherein the at least one polyol cross-linking agent comprises a diol.

17. (canceled)

18. The method of claim 1, comprising drying the sulfonated polymer prior to adding the at least one cross-linking agent.

19. A fuel cell using a cross-linked proton exchange membrane prepared in accordance with claim 1.

20. A proton exchange membrane suitable for fuel cells, comprising: a cross-linked sulfonated polymer provided from a solution which has been cast and cured, the solution including a sulfonated polymer, having a degree of sulfonation higher than 0.6, dissolved in a polar casting solvent and at least one polyol cross-linking agent added to the dissolved sulfonated polymer in a ratio of the cross-linking agent molecules per repeat unit of the sulfonated polymer higher than or equal to 1 to generate cross-linking.

21. (canceled)

22. The proton exchange membrane of claim 20, wherein the ratio of polyol molecules per repeat unit of the sulfonated polymer in the solution is between 2 and 3.

23-30. (canceled)

31. The proton exchange membrane of claim 20, wherein the sulfonated polymer comprises sulfonated poly(ether ether ketone).

32. The proton exchange membrane of claim 20, wherein the polar casting solvent is selected from the group consisting of DMAc, NMP, DMF, butyrolactone, water, a mixture of water and acetone, and a mixture of water and alcohol.

33. (canceled)

34. The proton exchange membrane of claim 20, wherein the at least one polyol cross-linking agent comprises a diol.

35. (canceled)

36. (canceled)
